(19) United States
(12) Patent Application Publication
(10) Pub. No.: US 2014/0282091 A1
(43) Pub. Date: Sep. 18, 2014

(54) Collaborative Review and Approval of Medical Device Data Sets

(71) Applicant: CAREFUSION 303, INC., San Diego, CA (US)

(72) Inventors: Aron Weiler, San Diego, CA (US); Tim Henderson, San Diego, CA (US)

(73) Assignee: CAREFUSION 303, INC., San Diego, CA (US)

(21) Appl. No.: 13/829,870

(22) Filed: Mar. 14, 2013

(51) Int. Cl. G06F 3/0484

(52) U.S. Cl. CPC G06F 3/0484
USPC 715/753

(57) ABSTRACT

A collaborative review of a data set can be initiated that specifies a plurality of user-modifiable configuration settings for a medical device. Thereafter, first user-generated input can be received via a graphical user interface that selects at least one recipient entity to review the data set. Second user-generated input can be received that identifies an area of the data set to be reviewed by the at least one recipient entity. Data can then be transmitted to the at least one recipient entity that includes the identified area of the data set or a pointer to the identified area of the data set. Related apparatus, systems, techniques and articles are also described.

### TECHNICAL FIELD

The subject matter described herein relates to a software platform providing collaborative review and approval of data sets for medical devices such as infusion pumps.

### BACKGROUND

Data sets define various configuration settings for medical devices. Such data sets allow entities such as caregivers and hospitals to customize the operation of such medical devices and, as a result, data sets for the same type of medical device can vary widely. For example, a data set can define a series of therapies that can be implemented by an infusion pump. These therapies can have user-defined infusion rate limits for continuous, bolus infusions, as well as other infusion types which, in turn, can vary based on the type of fluid/medication being delivered.

The generation and/or final approval of data sets typically require input from numerous individuals. This input can be used to ensure that best practices are incorporated so that caregivers can provide safe and optimal patient treatment. However, given the large number of involved individuals, the process of finalizing data sets can be lengthy or complex thereby delaying their adoption.

### SUMMARY

In one aspect, a collaborative review of a data set can be initiated that specifies a plurality of user-modifiable configuration settings for a medical device. Thereafter, first user-generated input can be received via a graphical user interface that selects at least one recipient entity to review the data set. Second user-generated input can be received that identifies an area of the data set to be reviewed by the at least one recipient entity. Data can then be transmitted to the at least one recipient entity that includes the identified area of the data set or a pointer to the identified area of the data set.

Third user-generated input can be received, via the graphical user interface, that includes comments characterizing the data set and such comments can accompany the data set when transmitted. The graphical user interface can include a plurality of concurrently displayed graphical user interface elements. In such cases, the first user-generated input can be received via a first graphical user interface element, the second user-generated input can be received via a second graphical user interface element separate and distinct from the first graphical user interface element, and the third user-generated input can be received via a third graphical user interface element separate and distinct from both the first graphical user interface element and the second graphical user interface element.

The first user-generated input can specify at least two recipient entities. In addition, in some variations, user-generated input can specify a sequence of review among the at least two recipient entities. The data (or a portion thereof) can be transmitted to the at least two recipient entities according to the specified sequence.

Users initiating the data set review, participating in the data set review, and/or approving the data set review can be authenticated using various measures and at various stages (such as pre-review and pre-approval).

Data can be received from one or more recipients that characterize review of the data set. Further, in some variations, the data characterizing review of the data set by the at least one recipient entity can be concurrently displayed. User-generated input can activate one or more graphical user interface elements (e.g., approve graphical user interface elements, etc.) displayed in the graphical user interface to approve the data set.

In addition, review of the data set can, in some cases, be delegated by recipient entities.

Computer program products are also described that comprise non-transitory computer readable media storing instructions, which when executed one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter provides a user-friendly platform for collecting, reviewing, and approving input from a large number of entities relating to a medical device data set.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 illustrates a sample portion of a data set specifying configuration settings for a medical device;

FIG. 2 is a view of a graphical user interface for initiating review of a data set by at least one recipient entity;

FIG. 3 is a view of a graphical user interface showing comments to be included with a data set to be reviewed by at least one recipient entity;

FIG. 4 is a view of a graphical user interface showing authentication of a user prior to approving a data set;

FIG. 5 is a view of a graphical user interface showing a data set and a state of review of the data set by at least one recipient entity;

FIG. 6 is a diagram showing a sequenced review of a data set; and

FIG. 7 is a process flow diagram illustrating initiation of a collaborative review of a data set.

### DETAILED DESCRIPTION

FIG. 1 is a diagram 100 providing a view of a graphical user interface of a data set editor application for generating data sets for medical devices. While the current description is mainly directed to data sets for medication/fluid infusion pumps and systems, it will be appreciated that the current subject matter is applicable to data sets for any type of medical device that gives a user an ability to modify various configuration settings such as ventilators. Following with the example of an infusion system, a data set can be characterized as a representation of best practice guidelines or settings of a hospital pharmacy with regard to IV drug and fluid and administration. The data set can comprise hospital care areas and delivery device configuration settings to promote the best practice guidelines of a hospital, customized by area, to prevent medication errors to optimize patient treatment. The configuration settings specified by a data set can comprise any features provided by the corresponding medical device that a typical end user might want to modify and/or customize. The data set typically excludes settings relating to basic core functionality of the medical devices (such as those that might be adjusted or modified through universal software/firmware upgrades, and the like).

A pharmacist using the graphical user interface illustrated in diagram 100 can input various values relating to each of a plurality of settings for a particular data set. These settings can pertain to varying aspects including, but not limited to, safeguards relating to medication total dose and delivery duration, customized anesthesia modes to provide dosing and delivery options not available with default settings of an infusion pump, bolus dose drug identification and rate limits to ensure safe medication delivery at very high or low rates, therapies that create one drug entry with different dosing options and limits for clinicians to customize treatment based on a patient's clinical condition, an IV fluid library to help configure rate limits for each IV fluid in a profile, customizable clinical advisories to remind clinicians of best practices throughout IV therapy, and patient-controlled analgesia (PCA) protocols to automatically pause a PCA infusion if the patient falls below hospital defined respiratory monitoring limits.

With reference again to the diagram 100 of FIG. 1, the editor interface shows certain settings relating to medications that are only directed to anesthesia applications (as opposed to those medications that apply to both anesthesia and non-anesthesia applications). In this view, a pharmacist can modify how an infusion pump handles continuous and bolus dosing of medications: dobutamine, dopamine, fentanyl, propofol, and sufentanil. It will be appreciated that this view provides only a subset of a data set as an infusion pump can have settings pertaining to a large number of medications which may be administered to a patient in connection with one of many courses of treatment. The view shows concentration levels, module types (i.e., types of infusion modules that can be administer the medication type), and various dosing parameters such as minimum and maximum fluid flow rates and the like. In addition, this view relates to how an infusion pump would be used in a pediatric intensive care unit (PICU) and as such, the various settings are directed to children which differ from how such medications would be administered to adults.

With reference to the diagram 200 of FIG. 2, the editor application can allow a user to initiate a review of a data set by one or more other entities. The user can specify, via a first graphical user interface element 210 (which can be a drop down list, an input box, etc.), one or more entities that are to review the data set. Entities can include one or more of: specifically identified individuals, groups of individuals, role-based entities (e.g., NICU review department) and the like. The user can select one or more entities to review the data set and optionally, a sequence amongst such entities to review the data set. In addition, as data sets can be lengthy and complicated, the review the user, via a second graphical user interface element 220 (which can be a drop down list, an input box, etc.), can specify what portion of the data set the entities are to review. In this example, the specific portion of the data set relates to PICU settings.

Furthermore, the user via, a third graphical user interface element 230, can annotate or otherwise add comments to the data set directly or as part of a cover note that will accompany the data set (or a portion of the data set) when distributed to the entities. The cover note, in some variations, accompanies the data set but is separate from the data set. The comments can pertain to any one of the entire data set, a master list, a care area, system configuration settings and the like. For example, but not limited to, the comments can be pertain to a master drug list, a master fluid list, a master indication list, a master advisory list, a master channel label list, system configuration settings in a data set, a master alert message list, base/rack/module configuration settings in a care area, pump configuration settings in a care area, syringe configuration settings in a care area, shared pump and syringe configuration settings in a care area.

The data set can be transmitted to the identified entities receiving the data set upon the user selecting a send graphical user interface element 240. In some cases, the entire data set is transmitted to the selected entity recipient(s), while in other cases only that selected portion of the data set (i.e., the portion identified using the second graphical user interface element 220). In other variations, a notification is sent to the selected entity recipients that there is a data set to review and the recipient can login to access the data set. Further, in other cases, a pointer such as a URL or short code can be sent to the selected entity recipient(s) which allows the recipient(s) to either access the data set and/or launch the editor application so that data set portion can be reviewed. FIG. 3 is a view 300 showing a confirmation page prior to transmission of the data set (or portion thereof or pointer thereto) to the intended recipients.

In some implementations, the user and/or the entities are required to have pre-defined permissions/authorization levels in order to initiate or otherwise participate in a data set review. In addition, in some implementations, the user and/or the entities are required to have pre-defined permissions/authorization levels in order to approve a data set. FIG. 4 is a view 400 showing an interface that can be used to authenticate a user/entity by having him or her enter in a user name and password. The authentication can be unique to an individual or it can relate to a group of users and the like.

FIG. 5 is a view 500 showing an interface that allows a user to approve a data set, or in some cases, changes made to a data set (in this case data set XYZ). The data set name and corresponding hospital can be identified in a first portion 510 as well as a date the data set was last modified as well as an identifier for the data set. A second portion 520 can show characterize entities that reviewed the data set, when such entities first commenced the review, and when such entities completed the review. This information can be used, to identify entities that have reviewed the data set and to, additionally, indicate any reviews that were started but not completed.

FIG. 6 is a diagram 600 illustrating a plurality of users 620-660 in communication via a communications network 610. In one example, a first user 620 initiates review of a data set. The first user 620 can specify a sequence in which other users 630, 650, 660 review the data set. Based on this sequence, the data set (or a portion thereof) is first sent to a second under 630 for review. This second user 630 instead of directly reviewing the data set, delegates such review to a third user 640. Once the third user 640 has completed its review, the sequence continues with the fourth user 650 followed by the fifth user 660. Each of the users 620-660 involved with the sequence can comment on, or in some cases, modify some or all of the data set. These comments/modifications are maintained and logged so that the first user 620 can determine whether or not to make any changes to the data set based on such comments/modifications. Stated differently, a user can, in some implementations, determine what changes to incorporate into the data set. Once the data set is completed/finalized, it can be pushed to (e.g., transmitted to the medical device if it is network enabled, uploaded, etc.) or otherwise associated with a medical device (e.g., an infusion pump, ventilator, etc.) so that such medical device can operate using the settings specified by the data set.

FIG. 7 is a process flow diagram 700 illustrating a method in which, at 710, collaborative review of a data set specifying a plurality of user-modifiable configuration settings for a medical device is initiated. Thereafter, first user-generated input is received, at 720, via a graphical user interface, that selects or otherwise specifies at least one recipient entity to review the data set. In addition, at 730, second user-generated input is received via the graphical user interface that identifies an area of the data set to be reviewed by the at least one recipient entity. In some variations, at 740, third user-generated input can be received via the graphical user interface that comprises comments. Subsequently, at 750, data is transmitted to the at least one recipient entity comprising the identified area of the data set or a pointer to the identified area of the data set (and optionally the comments if included).

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims. cm What is claimed is:

1. A computer-implemented method:
initiating collaborative review of a data set specifying a plurality of user-modifiable configuration settings for a medical device;
receiving, via a graphical user interface, first user-generated input selecting at least one recipient entity to review the data set;
receiving, via the graphical user interface, second user-generated input identifying an area of the data set to be reviewed by the at least one recipient entity; and
transmitting data to the at least one recipient entity comprising the identified area of the data set or a pointer to the identified area of the data set.

2. A method as in claim 1, further comprising:
receiving, via the graphical user interface, third user-generated input comprising comments characterizing the data set, wherein the data transmitted to the at least one recipient entity further comprise the comments.

3. A method as in claim 2, wherein the graphical user interface comprises a plurality of concurrently displayed graphical user interface elements, wherein the first user-generated input is received via a first graphical user interface element, the second user-generated input is received via a second graphical user interface element separate and distinct from the first graphical user interface element, and the third user-generated input is received via a third graphical user interface element separate and distinct from both the first graphical user interface element and the second graphical user interface element.

4. A method as in claim 1, wherein the first user-generated input specifies at least two recipient entities, and wherein the method further comprises: receiving user-generated input specifying a sequence of review among the at least two recipient entities, wherein the data is transmitted to the at least two recipient entities according to the specified sequence.

5. A method as in claim 1, further comprising:
authenticating a user initiating the data set review or approving the data set.

6. A method as in claim 5, further comprising:
authenticating each recipient entity prior to their reviewing the data set.

7. A method as in claim 1, further comprising:
receiving data from the at least one recipient entity characterizing review of the data set by the at least one recipient.

8. A method as in claim 7, further comprising:
concurrently displaying, in a graphical user interface, data characterizing review of the data set by the at least one recipient entity; and
receiving, user-generated input, activating an approve graphical user interface element displayed in the graphical user interface to approve the data set.

9. A method as in claim 1, further comprising:
delegating, by the at least one recipient entity, review of the data set to a different entity.

10. A non-transitory computer program product storing instructions, which when executed by at least one data processor of at least one computing system, perform operations comprising:
initiating collaborative review of a data set specifying a plurality of user-modifiable configuration settings for a medical device;
receiving, via a graphical user interface, first user-generated input selecting at least one recipient entity to review the data set;
receiving, via the graphical user interface, second user-generated input identifying an area of the data set to be reviewed by the at least one recipient entity; and
transmitting data to the at least one recipient entity comprising the identified area of the data set or a pointer to the identified area of the data set.

11. A computer program product as in claim 10, wherein the operations further comprise:
receiving, via the graphical user interface, third user-generated input comprising comments characterizing the data set, wherein the data transmitted to the at least one recipient entity further comprise the comments.

12. A computer program product as in claim 11, wherein the graphical user interface comprises a plurality of concurrently displayed graphical user interface elements, wherein the first user-generated input is received via a first graphical user interface element, the second user-generated input is received via a second graphical user interface element separate and distinct from the first graphical user interface element, and the third user-generated input is received via a third graphical user interface element separate and distinct from both the first graphical user interface element and the second graphical user interface element.

13. A computer program product as in claim 10, wherein the first user-generated input specifies at least two recipient entities, and wherein the method further comprises: receiving user-generated input specifying a sequence of review among the at least two recipient entities, wherein the data is transmitted to the at least two recipient entities according to the specified sequence.

14. A computer program product as in claim 10, wherein the operations further comprise:
authenticating a user initiating the data set review or approving the data set.

15. A computer program product as in claim 14, wherein the operations further comprise:
authenticating each recipient entity prior to their reviewing the data set.

16. A computer program product as in claim 10, wherein the operations further comprise:
receiving data from the at least one recipient entity characterizing review of the data set by the at least one recipient.

17. A computer program product as in claim 16, wherein the operations further comprise:
concurrently displaying, in a graphical user interface, data characterizing review of the data set by the at least one recipient entity; and
receiving, user-generated input, activating an approve graphical user interface element displayed in the graphical user interface to approve the data set.

18. A computer program product as in claim 10, wherein the operations further comprise:
delegating, by the at least one recipient entity, review of the data set to a different entity.

19. A system comprising:
at least one data processor; and
memory storing instructions, which when executed by the at least one data processor, perform operations comprising:
initiating collaborative review of a data set specifying a plurality of user-modifiable configuration settings for a medical device;
receiving, via a graphical user interface, first user-generated input selecting at least one recipient entity to review the data set;
receiving, via the graphical user interface, second user-generated input identifying an area of the data set to be reviewed by the at least one recipient entity; and
transmitting data to the at least one recipient entity comprising the identified area of the data set or a pointer to the identified area of the data set.

20. A system as in claim 19, wherein the operations further comprise:
receiving, via the graphical user interface, third user-generated input comprising comments characterizing the data set, wherein the data transmitted to the at least one recipient entity further comprise the comments; and
wherein:
the graphical user interface comprises a plurality of concurrently displayed graphical user interface elements, wherein the first user-generated input is received via a first graphical user interface element, the second user-generated input is received via a second graphical user interface element separate and distinct from the first graphical user interface element, and the third user-generated input is received via a third graphical user interface element separate and distinct from both the first graphical user interface element and the second graphical user interface element;
the first user-generated input specifies at least two recipient entities, and wherein the method further comprises: receiving user-generated input specifying a sequence of review among the at least two recipient entities, wherein the data is transmitted to the at least two recipient entities according to the specified sequence.
